(19) United States
(12) Patent Application Publication
(10) Pub. No.: US 2014/0282014 A1
(43) Pub. Date: Sep. 18, 2014

(54) PRESENTING SNAPSHOTS OF PLUG-IN CONTENT IN USER INTERFACES

(71) Applicants: Jonathan J. Lee, Cupertino, CA (US); Maciej Stachowiak, San Francisco, CA (US)

(72) Inventors: Jonathan J. Lee, Cupertino, CA (US); Maciej Stachowiak, San Francisco, CA (US)

(73) Assignee: Apple Inc., Cupertino, CA (US)

(21) Appl. No.: 13/803,659

(22) Filed: Mar. 14, 2013

(51) Int. Cl. G06F 3/048

(52) U.S. Cl. CPC G06F 3/048
USPC 715/733

(57) ABSTRACT

Presenting snap-shots of plug-in content in user interfaces. Input to present a user interface that includes content obtained by executing a plug-in is received. In response, the plug-in is executed to obtain the content. An image representative of the content is identified. Then, the execution of the plug-in is terminated, and the image representative of the content is displayed in the user interface. In the user interface, an object selectable to present the content obtained by executing the plug-in is displayed. When a selection of the object is received, the execution of the plug-in is re-instantiated to obtain the content, and the content is displayed in the user interface in place of the image.

### TECHNICAL FIELD

This disclosure relates generally to displaying content in a user interface by executing a computer software application, for example, a plug-in.

### BACKGROUND

Computer software applications can be implemented as computer instructions that can be stored on computer-readable media and executed by computer systems to perform operations. An amount of power that a computer system consumes when executing a computer software application can depend on types of operations that the computer system performs when executing the application. For example, power consumed by the computer system to receive high-resolution media content, such as digital video, from a server system over a network, such as the Internet, and present the content on a display device can be high. Relatively, power consumed by the computer system to execute a “Calculator” application to perform simple arithmetic addition can be low. Where the computer system is battery-powered, loss of battery power while performing operations to present content, such as that described above, may render the computer system unusable and may necessitate frequent re-charging of the battery.

### SUMMARY

This specification describes technologies relating to presenting snapshots of plug-in content in user interfaces provided by the computer systems.

In general, one innovative aspect of the subject matter described here can be implemented as a computer-implemented method. Input to present a user interface that includes content obtained by executing a computer software application is received. In response to receiving the input, the computer software application is executed to obtain the content. From the content, an image representative of the content is identified. An execution of the computer software application is terminated upon identifying the image representative of the content. The image representative of the content is displayed in the user interface.

This, and other aspects, can include one or more of the following features. An object can be displayed in the user interface. The object can be selectable to present the content obtained by executing the computer software application. A selection of the object can be received. In response to receiving the selection of the object, the execution of the computer software application to obtain the content can be re-instantiated. The obtained content can be displayed in the user interface in place of the image. Executing the computer software application to obtain the content can include determining execution parameters of the computer software application at a time of executing the computer software application, and storing the execution parameters. Re-instantiating the execution of the computer software application to obtain the content can include executing the computer software application using the execution parameters. In response to receiving the selection of the object, an identity of the computer software application can be stored. A subsequent input to present a different user interface that includes different content obtained by executing the computer software application can be received. Automatically and without user intervention, the computer software application can be executed to obtain the different content. The different content can be displayed in the different user interface.

At a time instant, it can be determined that that a period of time that has elapsed from a time of storing the identity of the computer software application to the time instant is greater than a threshold period. In response to determining that the period of time is greater than the threshold period, the identity of the computer software application can be deleted. A subsequent input to present a different user interface that includes different content obtained by another computer software application that is similar to the computer software application, can be received. Automatically and without user intervention, the other computer software application can be executed to obtain the different content. The different content can be displayed in the different user interface. It can be determined that the other computer software application is similar to the computer software application based on at least one of a data object model (DOM) structure of content presented in the user interface, an identifier of the DOM structure of the content presented in the user interface, or a combination of first Uniform Resource Locator (URL) that references the content presented in the user interface, a Multipurpose Internet Mail Extensions (MIME) type of the computer software application, and a second URL that references the computer software application.

The content can be visual content that includes a sequence of images, wherein the image representative of the content to be presented in the portion is included in the sequence. Displaying the obtained content in the user interface can include displaying the visual content beginning at the image. Executing the computer software application to obtain the content can include executing the computer software application to obtain each image of the sequence. Identifying the image representative of the content can include identifying an image of the sequence that satisfies a threshold value, and providing the identified image that satisfies the threshold value as the image representative of the content. It can be determined that the image of the sequence does not satisfy the threshold value. A next image of the sequence can be obtained. It can be determined if the next image of the sequence satisfies the threshold value. Identifying the image of the sequence that satisfies the threshold value can include determining if the image of the sequence satisfies the threshold value by identifying pixels included in the image, comparing each pixel with each adjacent pixel to determine a difference in image parameters associated with each pixel and each adjacent pixel, aggregating differences associated with the pixels included in the image, and determining if the differences satisfy the threshold value. Comparing each pixel with each adjacent pixel to determine the difference in image parameters associated with each pixel and each adjacent pixel can include overlaying a sampling grid over the pixels included in the image.

A size of a portion of the user interface in which the content is to be presented can be determined. The object selectable to present the content obtained by executing the computer software application can be displayed in the user interface either automatically or responsive to user input based on the size of the portion relative to a size of the user interface. It can be determined that the size of the portion relative to the size of the user interface is less than a threshold size. In response to determining that the size of the portion relative to the size of the user interface is less than the threshold size, the selectable object can be displayed upon detecting a selection of the portion of the user interface. Detecting the selection of the portion of the user interface can include detecting at least one of a mouse-over event, or a mouse-move event, or a mouse-out event over the portion of the user interface. It can be determined that the size of the portion relative to the size of the user interface is greater than the threshold size. In response to determining that the size of the portion relative to the size of the user interface is greater than the threshold size, the selectable object can be automatically displayed without user interaction within the user interface. The computer software application can be a plug-in executing in the user interface.

Other innovative aspects of the subject matter described here can be implemented as a computer-readable medium storing instructions executable by one or more processors to perform operations described here, or as a system including the computer-readable medium and the one or more processors, or both.

The details of one or more embodiments of the subject matter described in this specification are set forth in the accompanying drawings and the description below. Other features, aspects, and advantages of presenting snapshots of plug-in content in user interfaces will become apparent from the description, the drawings, and the claims.

### BRIEF DESCRIPTION OF THE DRAWINGS

FIGS. 1A and 1B illustrate an example computer system to present snapshots in user interfaces.

FIGS. 2A and 2B illustrate example user interfaces provided by executing computer software applications using the computer system of FIGS. 1A and 1B.

FIG. 3 illustrates example components of the computer system of FIGS. 1A and 1B.

FIGS. 4A and 4B are flowcharts of example processes implemented by the example components shown in FIG. 3.

FIG. 5 is a flowchart of an example process implemented by the example components shown in FIG. 3.

FIG. 6 is a flowchart of an example process implemented by the example components shown in FIG. 3.

FIG. 7 is a flowchart of an example process implemented by the example components shown in FIG. 3.

FIG. 8 is an architecture of the example computer system of FIGS. 1A and 1B.

Like reference numbers and designations in the various drawings indicate like elements.

### DETAILED DESCRIPTION

This disclosure describes computer-implemented methods, computer-readable media, and computer systems for presenting snapshots of plug-in content in user interfaces. Computer systems can implement computer software applications that can present digital media content, for example, video, audio, images, text, and the like, in a display device. For example, a computer system can be connected to a content host server through the Internet. The computer system can execute an Internet browser software application to present, in a display device, a user interface (for example, an Internet browser) and to present content in the user interface. The content that the content host server provides to the computer system can include visual content, which can be the main content that a user of the computer system wants to see or ancillary or secondary content (for example, an advertisement) which the user may not be interested in seeing. Examples of visual content can include video content or content used by a publisher of a website to create an immersive website, for example, for a clothier or a restaurant, a video game, or a productivity application (or combinations of them). If the computer system executes a plug-in to display the advertisement, then the computer system may exhaust power to perform an operation that the user may not desire.

Configuring the Internet browser software application to not execute any plug-ins absent user input can prevent the computer system from automatically executing to perform undesirable operations. If the content that the content host server provides includes content that can be presented only by executing the plug-in, then the user may not be able to see any content. Alternatively or in addition, the Internet browser application may present a placeholder (for example, a grayscale image) in the user interface in place of the content, resulting in the user interface having a broken appearance. Also, unless the user knows the type of content that is received by the computer system, the user may not be able to easily identify a plug-in to activate and another plug-in to ignore.

This disclosure describes an alternative to always executing the plug-in or permanently disabling the plug-in. As described below, the plug-in can be executed, for example, in the background, to obtain an image that is representative of the content to be presented by executing the plug-in. Once the image is obtained, the execution of the plug-in can be terminated. The obtained image can be displayed in the user interface as a snapshot of the content that will be presented in the user interface if the computer system executes the plug-in. Upon viewing the snapshot, the user can provide an input to the computer system requesting the video content to be presented in the user interface. In response to receiving the input, the computer system can re-instantiate an execution of the plug-in to obtain a remainder of the content, and present the content in the user interface. In this manner, a power (for example, battery power) consumed by the computer system to present content by executing a plug-in can be conserved. In addition, because the placeholder (i.e., the grayscale image) that results in the broken appearance is replaced by a snapshot that is representative of the content, a user experience can be improved.

FIGS. 1A and 1B illustrate an example computer system 102 to present snapshots in user interfaces. In general, the computer system 102 can be any computer, for example, a desktop computer, a laptop computer, a tablet computer, a smartphone, a personal digital assistant (PDA), and the like. The computer system 102 may be operable using battery power. The computer system 102 can implement one or more computer software applications as computer instructions stored on a computer-readable medium 150 and executed by data processing apparatus 152. The one or more applications can include a computer software application (for example, Internet browser applications) which, when executed by the computer system 102, can provide one or more user interfaces (for example, Internet browsers) to present content. The one or more applications can also include a computer software application (for example, a plug-in) which, when executed by the computer system 102, can initiate a video content player to play video content.

The computer system 102 can be connected to a display device 104 (for example, a CRT or LCD monitor, a touchscreen, and the like) in which the computer system 102 can display a user interface 106 by executing one or more of the computer software applications described here. The computer system 102 can be connected to one or more input devices, for example, a keyboard 108 (such as physical or virtual keyboard), a position indicator 110 (such as a mouse, a touchscreen, a touch pad), and the like. The computer system 102 can receive input to perform operations from a user using the one or more input devices. In response to receiving the input, the computer system 102 can execute the computer software applications to present the output in the display device 104, for example, display the output in the user interface 106.

The computer system 102 can be connected to one or more server computer systems (for example, server computer system 114a, server computer system 114b, server computer system 114c) through one or more networks 112, for example, the Internet. Each server computer system can store content, which the computer system 102 can receive over the one or more networks 112 for presenting on the display device 104. For example, in response to input to execute the computer system 102, the computer system 102 can display an Internet browser in the display device 104. Through the Internet browser, the computer system 102 can receive a Uniform Resource Locator (URL) that references a webpage of a website hosted by one of the server computer systems, for example, the server computer system 114a. The computer system 102 can transmit the URL to the server computer system 114a that hosts the webpage over the Internet. In response, the server computer system 114a can transmit content included in the webpage over the Internet to the computer system 102. The computer system 102 can display the webpage and the content included in the webpage in the Internet browser.

In some implementations, the computer system 102 can receive input to present a user interface 106 (for example, the Internet browser) that includes content (for example, digital video content) obtained by executing a computer software application (for example, the plug-in). In response to receiving the input, the computer system 102 can execute the computer software application to obtain the content. The computer system 102 can identify, from the content, an image that is representative of the content. The computer system 102 can terminate an execution of the computer software application upon identifying the image representative of the content. The computer system 102 can display, in the user interface 106, the image 120 representative of the content.

The computer system 102 can additionally display, in the user interface 106, an object 122 selectable to present the content obtained by executing the computer software application. The computer system 102 can receive a selection of the object 122, for example, by a positioning of a position indicator 124 controlled by an input device. In response to receiving the selection of the object 122, the computer system 102 can re-instantiate the execution of the computer software application (i.e., reload the computer software application) to obtain the content, and display the obtained content 130 (FIG. 1B) in the user interface 106 in place of the image 120. Examples of the operations performed by the computer system 102 are described below with reference to FIGS. 2A and 2B.

FIGS. 2A and 2B illustrate example user interfaces provided by executing computer software applications using the computer system of FIGS. 1A and 1B. The computer system 102 can execute a computer software application (for example, the Internet browser application) to request and receive content from the server computer system 114a over the one or more networks 112. To obtain all or a portion of the content for displaying in the display device 104, the computer system 102 can execute another computer software application, for example, the plug-in. FIG. 2A illustrates an example of a user interface 200 (for example, the Internet browser) in which the computer system 102 did not execute the computer software application (i.e., the plug-in) to obtain the portion of the content. For example, a user may have previously disabled the execution of all plug-ins. Because the computer system 102 was unable to execute the plug-in to obtain the content, the computer system can display the object 202 in a portion of the user interface 200 in which the content should have been displayed.

FIG. 2B illustrates an example of a user interface 210 (for example, the Internet browser) in which the computer system 102 executed the plug-in to obtain the content and to identify an image representative of the content. The computer system 102 can then terminate the execution of the plug-in and display the image 212 in the user interface 210. In addition, the computer system 102 can display the selectable object 214 to communicate to a user that the image 214 is representative of (i.e., is a snapshot of) content and that, to display the content, the user can select a portion of the user interface 210, for example, the image 212 or the object 214.

The computer system 102 can display the selectable object 214 either automatically or in response to input. In some implementations, the computer system 102 can determine a size of a portion of the user interface 210 in which the content is to be presented. The computer system 102 can display, in the user interface 210, the object 214 either automatically or responsive to user input based on the size of the portion relative to a size of the user interface 210. For example, if the computer system 102 determines that the size of the portion relative to the size of the user interface is less than a threshold size, then the computer system 102 can display the object 214 upon detecting user interaction with the user interface 210, for example, a selection of any portion of the user interface 210. An example of the selection of the portion of the user interface 210 can include a mouse-over event from outside the portion to within the portion, a mouse-move event within the portion, or a mouse-over event from within the portion to outside the portion. In another example, the computer system 102 can determine that the size of the portion relative to the size of the user interface is greater than the threshold size. In response, the computer system 102 can automatically display the object 214 in the user interface 210 without user interaction with the user interface 210.

FIG. 3 illustrates example components of the computer system 102 of FIGS. 1A and 1B. Each component of the computer system 102 can be implemented as computer instructions stored on a computer-readable medium (for example, the computer-readable medium 150) and executable by data processing apparatus (for example, the data processing apparatus 152). Exemplary operations performed by the components of the computer system 102 are described below with reference to flowcharts shown in FIGS. 4-7.

FIG. 4A is a flowchart of an example process 400a implemented by the example components shown in FIG. 3. The process 400a can be implemented as computer instructions stored on the computer-readable medium 150 and performed by the data processing apparatus 152. At 402, input to present a user interface that includes content obtained by executing a computer software application can be received. For example, the computer system 102 can receive input from a user using one of the input devices. In response, an application execution unit 302 can execute the Internet browser application to display the user interface 106 (i.e., the Internet browser) and to receive content to be displayed in the user interface 106. The content can include video content that can be presented by executing the plug-in. The computer system 102 can determine if the plug-in has been disabled. If the plug-in has been disabled, then the computer system 102 may not cause the application execution unit 302 to execute the plug-in.

At 404, in response to receiving the input, the computer software application can be executed to obtain the content. For example, the application execution unit 302 can execute the computer software application (i.e., the plug-in) to obtain a portion of the content. In some implementations, the application execution unit 302 can execute the plug-in in the background to obtain a portion of the content.

At 406, an image representative of the content can be identified from the portion of the content. For example, the content to be obtained by executing the plug-in can be digital video content that includes a sequence of images. As described below, the image that is representative of the content to be presented in the portion of the user interface can be included in the sequence. A snapshot identification unit 306 and a snapshot evaluation unit 308 can identify the representative image from the sequence of images, as described below with reference to FIG. 5.

At 408, an execution of the computer software application can be terminated upon identifying the image representative of the content. For example, the application execution unit 302 can receive a notification from the snapshot evaluation unit 308 that an image included in the portion of the video content has been obtained and that the obtained image is representative of the video content. In response to receiving the notification, the application execution unit 302 can terminate (i.e., stop or kill) the execution of the plug-in.

At 410, the image representative of the content can be displayed in the user interface. For example, a content presentation unit 310 can display the image (for example, the image 120) identified and evaluated by the snapshot identification unit 306 and the snapshot evaluation unit 308 in the user interface 106.

At 412, an object selectable to present the content generated by executing the computer software application can be displayed. For example, the content presentation unit 310 can display the selectable object (for example, the selectable object 122) in the user interface 106. As described above, the computer system 102 can cause the content presentation unit 310 to display the object automatically (i.e., without user interaction with the user interface 106) or in response to user input based on a size of the portion of the user interface in which the video content is to be presented relative to a size of the user interface. Thus, in some implementations, the computer system 102 can detect a mouse-move within the edges of the image or a mouse-over over the user interface, and, in response, cause the content presentation unit 310 to display the object.

At 414, a selection of the object can be received. For example, the computer system 102 can detect a positioning of the cursor 124 adjacent to (i.e., near or on) the object 122 and a selection (for example, a touch selection, a mouse click, an audio selection, and the like) of the object 122. Alternatively, a selection of the image can be received. The selection of the object or the image can represent input from the user to re-instantiate an execution of the plug-in.

At 416, the execution of the computer software application can be re-instantiated to obtain the content. At 418, the obtained content can be displayed in the user interface in place of the image. For example, the content presentation unit 310 can display the video content 130 obtained when the application execution unit 302 executed the plug-in in the user interface 106 in place of the image 120 and the selectable object 122.

FIG. 4B is a flowchart of an example process 400b implemented by the example components shown in FIG. 3. The process 400b can be implemented as computer instructions stored on the computer-readable medium 150 and performed by the data processing apparatus 152. At 452, a selection can be detected. As described above, either the object or the image can be selected. On the image, more specifically, a certain location can be selected. Either selection can represent input to re-instantiate an execution of the plug-in. Thus, at 454, the plug-in can be re-instantiated to obtain the content in response to detecting the selection. At 456, it can be determined if the object was selected or if a location on the image was selected. If the object was selected (decision branch “Object”), then no additional action need be performed. The plug-in can obtain the content, which can be presented in place of the image.

If the location on the image was selected (decision branch “Image”), then, at 458, the location at which the selection was received (for example, a position of the cursor when the user clicked the mouse) can be determined. At 460, a pass-through of the selection to the location can be implemented after a period of time has expired. The period of time can be sufficient for at least a portion of the content to be obtained by the plug-in and displayed in the user interface in place of the image. Without the delay in implementing the pass-through, a user-experience will be one in which the user has selected the image to view the content but the plug-in has not yet obtained the content. With the delay in implementing the pass-through, the plug-in would have obtained the content and the content presentation unit 310 would have started to present the content by the time the user's click is passed through, resulting in an improvement in user experience. In some implementations, the period of time can be very small (for example, a few seconds such as two seconds or less).

FIG. 5 is a flowchart of an example process 500 implemented by the example components shown in FIG. 3. The process 500 can be implemented as computer instructions stored on the computer-readable medium 150 and performed by the data processing apparatus 152. As described above, the snapshot identification unit 306 can identify a portion of the content obtained when the application execution unit 302 executes the plug-in. The snapshot evaluation unit 308 can evaluate a fitness of the identified portion to be presented as being representative of the content to be obtained by executing the plug-in.

At 502, the computer software application (for example, the plug-in) can be executed to generate an image of a sequence of images included in the video content. For example, the application execution unit 302 can execute the plug-in for a duration (for example, less than or more than 1 second) and obtain an image of the sequence. The duration for which the application execution unit 302 executes the plug-in can depend on a duration of initialization of the plug-in. Some plug-ins can buffer the video content during which the plug-in appears as spinning icon on the user interface. For such plug-ins, the duration for which the application execution unit 302 executes the plug-in to generate an image can include a duration of the initialization. As described above, once the snapshot identification unit 306 has obtained an image of the sequence, the application execution unit 302 can continue to execute the plug-in while the snapshot evaluation unit 308 evaluates the fitness of the image to be representative of the content.

To do so, the snapshot evaluation unit 308 can evaluate whether the image has enough useful content. By evaluating the image, the snapshot evaluation unit 308 can identify an image of the sequence that satisfies a threshold value, and provide the identified image that satisfies the threshold value as the image representative of the content. An example algorithm for evaluating the fitness of the image is described below. Any algorithm, for example, one that is fast and simple to implement can be used to evaluate the fitness of the image.

At 504, the snapshot evaluation unit 308 can identify pixels included in the obtained image. For example, the snapshot evaluation unit 308 can convert the image into a grayscale image and overlay a sampling grid over the pixels included in the grayscale image. The sampling grid can be a grid of dots (for example, a 7×7 grid) spread across the entire image. The grid can be of any size that does not significantly increase a duration of evaluating the fitness of the image.

At 506, the snapshot evaluation unit 308 can compare each pixel with each adjacent pixel. For example, the snapshot evaluation unit 308 can determine image parameters of each pixel (such as, brightness, opacity, and the like) and compare the features with similar features of each adjacent pixel. At 508, the snapshot evaluation unit 308 can determine a difference in image parameters associated with each pixel and each adjacent pixel. At 510, the snapshot evaluation unit 308 can aggregate differences associated with the pixels included in the image. For example, the snapshot evaluation unit 308 can aggregate the difference in luminance of a pixel with its neighboring pixels. At 512, the snapshot evaluation unit 308 can determine whether the differences satisfy the threshold value.

If the snapshot evaluation unit 308 determines that the differences satisfy the threshold value (decision branch “YES”), then, at 516, the snapshot evaluation unit 308 can provide the obtained image to be displayed in the user interface. Sometimes, however, the snapshot evaluation unit 308 may determine that the aggregate differences do not satisfy the threshold value (decision branch “NO”) and that the image is not fit to be representative of the video content. For example, the aggregate sum of the differences for an image that is blank or mostly blank will be very low. For example, if the image is one of the spinning icon surrounded by a uniformly white or gray color, then the aggregate difference of the luminance will be zero or close to zero, and consequently, less than the threshold value. Such an image is not fit to be representative of the video content. In that situation, at 514, the computer system 102 can obtain a next image in the sequence.

As described above, the application execution unit 302 continues to execute the plug-in while the snapshot identification unit 306 and the snapshot evaluation unit 308 obtain and evaluate an image in the sequence. The snapshot identification unit 306 can obtain the next image from the content obtained by the executing plug-in. For example, the snapshot identification unit 306 can implement a timer for a duration of time (such as, 1 second), obtain the image after the timer has run for the duration, and then reset the timer. If the snapshot evaluation 308 determines that the obtained image is unsuitable by implementing the steps described above, the snapshot identification unit 306 can run the timer again for the duration of time, obtain the next image after the timer has run for the duration, and then reset the timer. The snapshot evaluation unit 308 can evaluate the next image by repeating repeat process steps 504, 506, 508, and 510. This process can continue until the snapshot evaluation unit 308 identifies a useful image. In some implementations, this process can continue until a certain duration (for example, 10 seconds) has expired. If the snapshot evaluation unit 308 has not yet identified a useful image before the certain duration has expired, then the content presentation unit 310 can present the last image that the snapshot evaluation unit 308 evaluated in the user interface. At this stage, the application execution unit 302 can terminate the execution of the plug-in.

When the snapshot evaluation unit 308 determines that an obtained image is a suitable snapshot of the video content, then the content presentation unit 310 can display the image 122 in the user interface 106, for example, as a placeholder or a poster for the video content. The content presentation unit 310 can give the image 122 one or more visual treatments that indicate that the image represents video content to be obtained by executing a plug-in. One such visual treatment is the selectable object 124. In some implementations, the content presentation unit 310 can display the image 122 as if the plug-in were running with minimal or no additional visual treatment. With useful content, the user may be encouraged to naturally interact with the image 122 as if the image were live. The interaction is an input to the computer system 102 that the user wishes the plug-in to be executed. In response, the application execution unit 302 can re-instantiate the plug-in.

FIG. 6 is a flowchart of an example process implemented by the example components shown in FIG. 3. As described below with reference to FIG. 6, the application execution unit 302 can activate the plug-in using execution parameters of the plug-in at the time of terminating the plug-in. For example, at 602, the application execution unit 302 can determine execution parameters of the computer software application at a time of executing (i.e., loading) the computer software application. The execution parameters of the plug-in can include, for example, a URL that the plug-in referenced, other parameters that the computer instructions (for example, the HTML or the JavaScript) may have provided as input to the plug-in, and the like. At 604, the application execution unit 302 can store the execution parameters. At 606, the application execution unit 302 can terminate an execution of the computer software application, and, at 608, receive input to re-instantiate the execution of the plug-in, for example, in response to receiving a selection of the object 214. At 610, the application execution unit 302 can execute the plug-in using the stored execution parameters.

In sum, the execution parameters with which the execution of the plug-in is re-instantiated after identifying the image representative of the video content can be the same as the execution parameters with which the plug-in was loaded to obtain the image. As described above, the execution of the plug-in is continued when the user provides input requesting the video content, for example, clicks on the user interface. Because the user is interacting with the image obtained by the plug-in as the image appeared after a short delay to execute the plug-in, the computer system 102 waits the same duration before sending the user's activating click. To do so, in some implementations, the computer system 102 can build a delay into passing through the click and timing the injection of the click to where the plug-in was when the snapshot was identified. In this manner, the video content that is displayed in the user interface upon re-instantiating the execution of the plug-in responsive to user input begins at the image that was obtained immediately prior to terminating the execution of the plug-in. Because the plug-in would have already been locally stored in cache after the first instance of its execution, when the user selects the user interface, the plug-in may initialize faster than when executed at the first instance.

The user's selection of the user interface 106, for example, the selectable object 122, signals the user's intent to execute the plug-in to obtain and present the video content. In some implementations, the computer system 102 can track the plug-ins that the user has activated on a first user interface (for example, a first webpage) and execute the same or similar plug-ins (for example, plug-ins executing in other webpages or plug-in executing on the same webpage during a current or subsequent visit to the webpage) automatically, i.e., without user intervention. To do so, the computer system 102 can maintain a whitelist of plug-ins. Automatically executing plug-ins on the whitelist without user intervention can improve the user experience since the user is not required to activate a plug-in every time that the user wants to view content. For example, the computer system 102 can maintain the whitelist of plug-ins, for example, store the list of plug-ins on a computer-readable storage 312. An application comparison unit 304 can determine whether a plug-in is similar to a previously executed plug-in.

The computer system 102 can determine if a plug-in is similar to a previously executed plug-in based on one or more factors including a data object model (DOM) structure of the content presented in the user interface (i.e., the webpage), an identifier of the DOM structure content presented in the user interface, a combination of a URL that references the webpage, a URL that references the content that is being obtained by executing the computer software application, an identifier (for example, a MIME type) of the computer software application, and another URL that references the computer software application, or combinations of them. Additional factors can include, cascading style sheet (CSS) rules, placement from a visual standpoint, placement in the DOM structure, plugins' unique names, and the like. For example, a URL www.webpage.com can reference a webpage displayed in the Internet browser, and another URL www.plugin.com can reference a plug-in to be executed to present video content included in the webpage. When the user provides input to the computer system 102 indicating that the user wants to view the video content, the computer system 102 can execute the plug-in. The computer system 102 can store the domain name in the URL of the webpage (i.e., webpage.com) and the domain name in the URL of the plug-in (i.e., plugin.com) in the computer-readable storage 312.

Subsequently, the user can access the same webpage or other webpages of the same domain. Because the application comparison unit 304 determines that the domain name of the URL referencing the webpage and the domain name of the URL referencing the plug-in match those stored in the computer-readable storage 312, the computer system 102 automatically executes the plug-in without user intervention. Alternatively, the same webpage can include different video content, which can be obtained by executing the same plug-in. The different video content can be an advertisement. The application comparison unit 304 can determine that, although the domain name that references the plug-in matches the domain name stored in the whitelist, the domain name that references the video content does not. Responsively, the computer system 102 can terminate the execution of the plug-in, for example, until the computer system 102 receives input from the user. In another example, after accessing the webpage, the user can access a different webpage that executes the same plug-in or a different plug-in. The application comparison unit 304 can compare the pair of the webpage domain name and the plug-in domain name with the pair stored in the whitelist to determine if the plug-in in the different webpage is similar to the previously executed plug-in.

In some implementations, the computer system 102 can implement an expiration policy for the plug-ins listed in the whitelist. For example, to display an advertisement video in the Internet browser, the user may have provided input to execute the plug-in. In response to the input, the computer system 102 can store the plug-in in the whitelist on the computer-readable storage 312. But, the user may not want such a video to be displayed again. If the whitelist persists perpetually, then the user may need to disable the plug-in each time that the Internet browser displays content that is obtained by executing the plug-in. In such situations, the computer system 102 can implement the expiration policy to purge plug-ins from the whitelist, so that the user needs to provide input for the plug-in to either remain on the whitelist or be added to the whitelist.

FIG. 7 is a flowchart of an example process 700 implemented by the example components shown in FIG. 3. The process 700 can be implemented as computer instructions stored on the computer-readable medium 150 and performed by the data processing apparatus 152. At 702, the application execution unit 302 can receive input to execute the computer software application (i.e., the plug-in) to obtain content. At 704, the computer system 102 can determine a first time instant at which the input is received. At 706, at a second time instant after the first time instant, the application execution unit 302 can receive input to present a different user interface that includes different content obtained by executing the computer software application (i.e., the plug-in). At 708, the computer system 102 can determine a period of time between the first time instant and the second time instant.

At 710, the computer system 102 can determine if the period of time satisfies a threshold. The period of time can be, for example, one or more weeks, one or more months, or any other suitable period. If the computer system 102 determines that a period of time that has elapsed from a time of storing the identity of the plug-in (i.e., the first time instant) to the second time instant is less than the threshold (decision branch “YES”), then the application execution unit 302 can automatically and without user intervention execute the plug-in to obtain the content. If the computer system 102 determines that the period of time that has elapsed from the time of storing the identity of the plug-in to the second time instant is greater than the threshold (decision branch “NO”), then the computer system 102 can implement processes similar to those described above.

That is, at 714, the application execution unit 302 can execute the plug-in to obtain a portion of the content. At 716, the snapshot identification unit 306 and the snapshot evaluation unit 308 can identify an image representative of the content from the portion. At 718, the content presentation unit 310 can display the image in the user interface, and, at 720, the application execution unit 302 can terminate the execution of the plug-in. To determine if the period of time that has elapsed from the first time instant to the second time instant is greater than the threshold, the computer system 102 can associate a clock with the plug-in, and determine the period of time using the clock.

In some implementations, the computer system 102 can extend the expiration time for the plug-in in the whitelist based on an interaction of the user with the plug. For example, if the computer system 102 detects user interaction with the plug-in (i.e., that the user has selected to execute the plug-in in the same or a different webpage), then the computer system 102 can extend the expiration time from the time of the interaction. Alternatively, if the computer system 102 does not detect any interaction with the plug-in, then the computer system 102 can remove the plug-in from the whitelist and return to snapshotting, as described above. In some implementations, the computer system 102 can display the whitelist in a user interface from which the user can remove plug-ins or to which the user can add plug-ins.

FIG. 8 is a block diagram of an exemplary architecture for implementing the features and operations described above. Other architectures are possible, including architectures with more or fewer components. In some implementations, architecture 800 includes one or more processors 802 (e.g., dual-core Intel® Xeon® Processors), one or more output devices 804 (e.g., LCD), one or more network interfaces 806, one or more input devices 808 (e.g., mouse, keyboard, touch-sensitive display, microphone to receive audio input) and one or more computer-readable mediums 912 (e.g., RAM, ROM, SDRAM, hard disk, optical disk, flash memory, etc.). These components can exchange communications and data over one or more communication channels 810 (e.g., buses), which can utilize various hardware and software for facilitating the transfer of data and control signals between components.

The term “computer-readable medium” refers to a medium that participates in providing instructions to processor 802 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 812 can further include operating system 814 (e.g., a Linux® operating system) and network communication module 816. Operating system 814 can be one or more of multi-user, multiprocessing, multitasking, multithreading, real time, etc., or combinations of them. Operating system 814 performs basic tasks, including but not limited to: recognizing input from and providing output to devices 804, 808; keeping channel and managing files and directories on computer-readable mediums 812 (e.g., memory or a storage device); controlling peripheral devices; and managing traffic on the one or more communication channels 810. Network communications module 816 includes various components for establishing and maintaining network connections (e.g., software for implementing communication protocols, such as TCP/IP, HTTP, etc.).

Architecture 800 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks, magneto-optical disks, and optical disks. Storage devices suitable for tangibly embodying computer program instructions and data include all forms of non-volatile memory, including by way of example, semiconductor memory devices, such as EPROM, EEPROM, and flash memory devices, magnetic disks such as internal hard disks and removable disks, magneto-optical disks, and CD-ROM and DVD-ROM disks. The processor and the memory can be supplemented by, or incorporated in, ASICs (application-specific integrated circuits).

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them, installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the invention have been described. Nevertheless, it will be understood that various modifications can be made without departing from the spirit and scope of the invention. For example, in the example implementations described above, the plug-in was terminated upon identifying an image representative of the content and subsequently re-instantiated in response to receiving input to execute the plug-in. In alternative implementations, the plug-in can be paused (i.e., temporarily stopped) instead of being terminated, and continued from the paused state instead of being re-instantiated. In another example, if the plug-in has audio associated with video, then, to identify an image that is representative of the video, the computer system 102 can execute the plug-in in the background in a process that excludes the audio. When the user selects the image in the user interface, then the computer system 102 can re-instantiate the plug-in, but in a process that includes audio.

In another example, to present content received from the server computer system 114c, the computer system 102 may need to execute multiple plug-ins. The computer system 102 can execute each plug-in as described above. To do so, the computer system 102 can associate a clock with each plug-in, and monitor durations associated with initialization, termination, and re-instantiation of each plug-in using the associated clock.

In a further example, the computer system 102 can determine that a plug-in is a 0×0 or a 1×1 pixel plug-in, for example, a plug-in that is used to coordinate activities between multiple plug-ins or to play audio, or a plug-in that is contained within an ancestor in the DOM that is of a similar size. Such plug-ins may be too small for a user to see in the user interface. The computer system 102 can execute such plug-ins as such plug-ins do not always consume significant power.

In some situations, when the plug-in is invisible, the techniques described above need not be implemented to obtain a snapshot. In some situations, a webpage is designed such that a result of user interaction with an element on the webpage that is not a plug-in, code in the webpage creates a plug-in. In such situations, an interaction by the user with the element is taken to mean that the user wants to interact with or watch the content. Consequently, the techniques described above may not be implemented to obtain a snapshot.

What is claimed is:

1. A computer-implemented method comprising:
receiving input to present a user interface that includes content obtained by executing a computer software application;
in response to receiving the input:
executing the computer software application to obtain the content,
identifying, from the content, an image representative of the content, and
terminating an execution of the computer software application upon identifying the image representative of the content; and
displaying, in the user interface, the image representative of the content.

2. The method of claim 1, further comprising:
displaying, in the user interface, an object selectable to present the content obtained by executing the computer software application;
receiving a selection of the object; and
in response to receiving the selection of the object:
re-instantiating the execution of the computer software application to obtain the content, and
displaying the obtained content in the user interface in place of the image.

3. The method of claim 2, wherein executing the computer software application to obtain the content comprises:
determining execution parameters of the computer software application at a time of executing the computer software application; and
storing the execution parameters, and
wherein re-instantiating the execution of the computer software application to obtain the content comprises executing the computer software application using the execution parameters.

4. The method of claim 2, further comprising:
in response to receiving the selection of the object, storing an identity of the computer software application;
receiving a subsequent input to present a different user interface that includes different content obtained by executing the computer software application;
automatically and without user intervention, executing the computer software application to obtain the different content; and
displaying the different content in the different user interface.

5. The method of claim 4, further comprising:
determining, at a time instant, that a period of time that has elapsed from a time of storing the identity of the computer software application to the time instant is greater than a threshold period; and
in response to determining that the period of time is greater than the threshold period, deleting the identity of the computer software application.

6. The method of claim 5, wherein determining, at the time instant, that the period of time is greater than the threshold period comprises:
associating a clock with the computer software application; and
determining the period of time using the clock.

7. The method of claim 2, further comprising:
receiving a subsequent input to present a different user interface that includes different content obtained by another computer software application that is similar to the computer software application;
automatically and without user intervention, executing the other computer software application to obtain the different content; and
displaying the different content in the different user interface.

8. The method of claim 7, further comprising determining that the other computer software application is similar to the computer software application based on at least one of a data object model (DOM) structure of content presented in the user interface, an identifier of the DOM structure of the content presented in the user interface, or a combination of first Uniform Resource Locator (URL) that references the content presented in the user interface, a Multipurpose Internet Mail Extensions (MIME) type of the computer software application, and a second URL that references the computer software application.

9. The method of claim 1, wherein the content is visual content that includes a sequence of images, wherein the image representative of the content to be presented in the portion is included in the sequence.

10. The method of claim 9, wherein displaying the obtained content in the user interface comprises displaying the visual content beginning at the image.

11. The method of claim 9, wherein executing the computer software application to obtain the content comprises executing the computer software application to obtain each image of the sequence.

12. The method of claim 11, wherein identifying the image representative of the content comprises:
identifying an image of the sequence that satisfies a threshold value; and
providing the identified image that satisfies the threshold value as the image representative of the content.

13. The method of claim 12, further comprising:
determining that the image of the sequence does not satisfy the threshold value;
obtaining a next image of the sequence; and
determining if the next image of the sequence satisfies the threshold value.

14. The method of claim 12, wherein identifying the image of the sequence that satisfies the threshold value comprises determining if the image of the sequence satisfies the threshold value by:
identifying pixels included in the image;
comparing each pixel with each adjacent pixel to determine a difference in image parameters associated with each pixel and each adjacent pixel;
aggregating differences associated with the pixels included in the image; and
determining if the differences satisfy the threshold value.

15. The method of claim 14, wherein comparing each pixel with each adjacent pixel to determine the difference in image parameters associated with each pixel and each adjacent pixel comprises overlaying a sampling grid over the pixels included in the image.

16. The method of claim 1, further comprising:
determining a size of a portion of the user interface in which the content is to be presented; and
displaying, in the user interface, the object selectable to present the content obtained by executing the computer software application either automatically or responsive to user input based on the size of the portion relative to a size of the user interface.

17. The method of claim 16, further comprising:
determining that the size of the portion relative to the size of the user interface is less than a threshold size; and
in response to determining that the size of the portion relative to the size of the user interface is less than the threshold size, displaying the selectable object upon detecting a selection of the portion of the user interface.

18. The method of claim 17, wherein detecting the selection of the portion of the user interface comprises detecting at least one of a mouse-over event, or a mouse-move event, or a mouse-out event over the portion of the user interface.

19. The method of claim 16, further comprising:
determining that the size of the portion relative to the size of the user interface is greater than the threshold size;
in response to determining that the size of the portion relative to the size of the user interface is greater than the threshold size, automatically displaying the selectable object without user interaction within the user interface.

20. The method of claim 1, wherein the computer software application is a plug-in executing in the user interface.

21. A non-transitory computer-readable medium storing instructions executable by one or more processors to perform operations comprising:
receiving input to present a user interface that includes content obtained by executing a plug-in;
in response to receiving the input:
executing the plug-in to obtain the content,
identifying, from the content, an image representative of the content, and
terminating an execution of the plug-in upon identifying the image representative of the content; and
displaying, in the user interface, the image representative of the content.

22. The medium of claim 21, the operations further comprising:
displaying, in the user interface, an object selectable to present the content obtained by executing the plug-in;
receiving a selection of the object; and
in response to receiving the selection of the object:
re-instantiating the execution of the plug-in to obtain the content, and
displaying the obtained content in the user interface in place of the image.

23. The medium of claim 21, further comprising:
detecting a selection of a location on the image;
re-instantiating the execution of the plug-in to obtain the content in response to detecting the selection;
implementing a pass-through of the selection of the location after a period of time has expired, wherein the period of time is sufficient for at least a portion of the content to be obtained by the plug-in and displayed in the user interface in place of the image.

24. The medium of claim 22, the operations further comprising:
in response to receiving the selection of the object, storing an identity of the plug-in;
receiving a subsequent input to present a different user interface that includes different content obtained by executing the plug-in;
automatically and without user intervention, executing the plug-in to obtain the different content; and
displaying the different content in the different user interface.

25. The medium of claim 24, the operations further comprising:
determining, at a time instant, that a period of time that has elapsed from a time of storing the identity of the plug-in to the time instant is greater than a threshold period; and
in response to determining that the period of time is greater than the threshold period, deleting the identity of the plug-in.

26. The medium of claim 25, wherein determining, at the time instant, that the period of time is greater than the threshold period comprises:
associating a clock with the plug-in; and
determining the period of time using the clock.

27. The medium of claim 22, the operations further comprising:
receiving a subsequent input to present a different user interface that includes different content obtained by another plug-in that is similar to the plug-in;
automatically and without user intervention, executing the other plug-in to obtain the different content; and
displaying the different content in the different user interface.

28. The medium of claim 27, the operations further comprising determining that the other plug-in is similar to the plug-in based on at least one of a data object model (DOM) structure of content presented in the user interface, an identifier of the DOM structure of the content presented in the user interface, or a combination of first Uniform Resource Locator (URL) that references the content presented in the user interface, a Multipurpose Internet Mail Extensions (MIME) type of the computer software application, and a second URL that references the plug-in.

29. The medium of claim 21, wherein the content is video content that includes a sequence of images, and wherein the image representative of the content to be presented in the portion is included in the sequence.

30. The medium of claim 29, wherein displaying the obtained content in the user interface comprises displaying the video content beginning at the image, and wherein executing the plug-in to obtain the content comprises executing the plug-in to obtain each image of the sequence.

31. A system comprising:
one or more processors; and
a computer-readable medium storing instructions executable by the one or more processors to perform operations comprising:
receiving input to present a user interface that includes content obtained by executing a computer software application;
in response to receiving the input:
executing the computer software application to obtain the content,
identifying, from the content, an image representative of the content, and
terminating an execution of the computer software application upon identifying the image representative of the content;
displaying, in the user interface, the image representative of the content;
displaying, in the user interface, an object selectable to present the content obtained by executing the computer software application;
receiving a selection of the object or the image; and
in response to receiving the selection of the object or the image:
re-instantiating the execution of the computer software application to obtain the content, and
displaying the obtained content in the user interface in place of the image.

32. The system of claim 31, wherein identifying the image representative of the content comprises:
identifying an image of the sequence that satisfies a threshold value; and
providing the identified image that satisfies the threshold value as the image representative of the content.

33. The system of claim 32, the operations further comprising:
determining that the image of the sequence does not satisfy the threshold value;
obtaining a next image of the sequence; and
determining if the next image of the sequence satisfies the threshold value.

34. The system of claim 32, wherein identifying the image of the sequence that satisfies the threshold value comprises determining if the image of the sequence satisfies the threshold value by:
identifying pixels included in the image;
comparing each pixel with each adjacent pixel to determine a difference in image parameters associated with each pixel and each adjacent pixel;
aggregating differences associated with the pixels included in the image; and
determining if the differences satisfy the threshold value.

35. The system of claim 34, wherein comparing each pixel with each adjacent pixel to determine the difference in image parameters associated with each pixel and each adjacent pixel comprises overlaying a sampling grid over the pixels included in the image.

36. The system of claim 31, the operations further comprising:
determining a size of a portion of the user interface in which the content is to be presented; and
displaying, in the user interface, the object selectable to present the content obtained by executing the computer software application either automatically or responsive to user input based on the size of the portion relative to a size of the user interface.

37. The system of claim 36, the operations further comprising:
determining that the size of the portion relative to the size of the user interface is less than a threshold size; and
in response to determining that the size of the portion relative to the size of the user interface is less than the threshold size, displaying the selectable object upon detecting a selection of the portion of the user interface.

38. The system of claim 37, wherein detecting the selection of the portion of the user interface comprises detecting a mouse-move event over the portion of the user interface.

39. The system of claim 36, the operations further comprising:
determining that the size of the portion relative to the size of the user interface is greater than the threshold size;
in response to determining that the size of the portion relative to the size of the user interface is greater than the threshold size, automatically displaying the selectable object without user interaction with the user interface.

40. The system of claim 31, wherein the computer software application is a plug-in executing in the user interface.
